(19) United States
(12) Patent Application Publication
(10) Pub. No.: US 2021/0190150 A1
(43) Pub. Date: Jun. 24, 2021

(54) CLUTCH UNIT FOR A POWERTRAIN WITH AN INTERLOCKING CLUTCH, AND HYBRID MODULE WITH A CLUTCH UNIT ACTING AS A DISCONNECT CLUTCH

(71) Applicant: Schaeffler Technologies AG & Co. KG, Herzogenaurach (DE)

(72) Inventors: Andreas Trinkenschuh, Bühl (DE); Steffen Lehmann, Ettlingen (DE); Wolfgang Hill, Karlsruhe (DE)

(73) Assignee: Schaeffler Technologies AG & Co. KG, Herzogenaurach (DE)

(21) Appl. No.: 16/762,593

(22) PCT Filed: Oct. 23, 2018
(86) PCT No.: PCT/DE2018/100866

§ 371 Date: May 8, 2020

(30) Foreign Application Priority Data
Nov. 22, 2017 (DE) 102017127577.0

(51) Int. Cl. F16D 11/14; F16D 23/02; B60K 6/387

(52) U.S. Cl. CPC F16D 11/14; F16D 23/02; F16D 2011/002; B60Y 2200/92; B60Y 2400/421; B60K 6/387

(57) ABSTRACT

A clutch unit for a powertrain of a motor vehicle comprises a torque input component which acts as a drive element and a torque output component which acts as an output element. The torque input component can be connected to the torque output component in torque-transmissive fashion via an engageable clutch. The clutch has a translationally movable clutch element configured and arranged such that in an actuation position, the clutch element allows a torque to be transmitted from the torque input component to the torque output component via an interlocking engagement.

### CROSS-REFERENCE TO RELATED APPLICATIONS

This application is the U.S. National Phase of PCT Appln. No. PCT/DE2018/100866 filed Oct. 23, 2018, which claims priority to DE 10 2017 127 577.0 filed Nov. 22, 2017, the entire disclosures of which are incorporated by reference herein.

### TECHNICAL FIELD

The disclosure concerns a clutch unit for a powertrain of a motor vehicle, with a torque input component acting as a drive element, e.g. for introducing torque from a drive machine such as an internal combustion engine or an electric machine, and with a torque output component acting as an output element, such as e.g. a transmission input shaft or an output shaft of a second drive machine, wherein the torque input component can be connected to the torque output component in torque-transmissive fashion via an engageable clutch. The disclosure furthermore concerns a hybrid module, for example for a P2 hybrid application or a hybrid application with two electric machines and an internal combustion engine, with a first drive machine which is permanently connected in torque-transmissive fashion to a transmission input shaft, and a second drive machine which can be engageably connected in torque-transmissive fashion to the transmission input shaft and/or an output shaft of the first drive machine via a clutch unit according to the disclosure. This means that the clutch unit is used preferably as a disconnect clutch (K0) between an internal combustion engine and a transmission, or a first electric machine and a second electric machine.

### BACKGROUND

So-called disconnect clutches are already known from the prior art, and are used to connect or decouple a drive machine to or from the powertrain. For example, DE 10 2014 206 330 A1 discloses a torque transmission device for hybrid vehicles which can be driven by means of an internal combustion engine and an electric drive, wherein the torque-transmission device is suitable for arrangement in a powertrain of the hybrid vehicle between the internal combustion engine and a transmission of the hybrid vehicle, and comprises an electric drive having a rotor rotating in particular about a central longitudinal axis of the torque transmission device; with a disconnect clutch for decoupling the internal combustion engine from the transmission; and with a centrifugal pendulum for damping vibrations, wherein the centrifugal pendulum is arranged axially inside the rotor. Friction clutches e.g. dry single-plate clutches, or multiplate clutches and wet plate clutches, are used as the disconnect clutch and are actuated by means of a central release system, a rotary transmission or a magnetic coil.

The prior art however always has the disadvantage that such friction disconnect clutches are subject to high wear and become very hot, so that often cooling is required, and the actuation of the clutch is bulky and cost-intensive.

### SUMMARY

It is thus the object of the disclosure to avoid or at least reduce the disadvantages of the prior art. In particular, a clutch unit should be provided which fulfils the functions of a disconnect clutch and at the same time is simpler, cheaper and more compact in its structure, actuation and control.

The object of the disclosure is achieved with a generic device according to the disclosure in that the clutch of the clutch unit has a translationally movable clutch element, which is designed and arranged such that in an actuation position, i.e. in the actuating position, the clutch element allows a torque to be transmitted from the torque input component to the torque output component via an interlocking engagement.

This means that in the actuating position, the clutch element connects the torque input component to the torque output component via an interlocking engagement for torque transmission so that the clutch is closed, and when not in the actuating position, the clutch element does not transmit torque so that the clutch is open and the clutch element is in a decoupled position i.e. a non-actuating position.

This has the advantage that the disconnect clutch is not formed as a friction clutch but as an interlocking clutch, actuation of which can be implemented more compactly and cheaply. Also, the above-mentioned disadvantages of a friction clutch with respect to wear and necessary cooling are avoided.

Advantageous embodiments are claimed in the subclaims and explained in more detail below.

Also, it is suitable if an electric motor is provided for translational movement of the clutch element. In other words, the clutch element can be displaced translationally by electric motor via the operation/actuation of the electric motor. The interlocking clutch is therefore actuatable by electric motor. Thus an actuation mechanism of the clutch may advantageously be formed with a small number of components. Also, because of the actuation of the clutch by electric motor, the time delay between control of the actuation and the closing or opening of the clutch is very short. Furthermore, in this way, the translational movement of the clutch element can be controlled precisely in both directions (for actuation and decoupling).

It is also advantageous if the electric motor is formed as a linear motor. In other words, the electric motor is configured such that a component driven thereby, i.e. the clutch element, is not put into a rotational motion but into a translational motion. It is advantageous here if a stator of the electric motor is attached to a stationary housing via a stator carrier for example. It is also preferred if the clutch element is connected, preferably fixedly, to a rotor of the electric motor, so that the clutch element is moved translationally together with the rotor.

It is also suitable if the rotor of the electric motor and/or the stator of the electric motor are/is arranged radially outside the clutch element. Thus the electric motor for actuating the clutch can be integrated compactly in the installation space available.

It is furthermore advantageous if the torque input component and the torque output component are configured and matched to each other such that a rotational speed of the torque input component and a rotational speed of the torque output component can be synchronized. This advantageously allows an interlocking clutch to be used as a disconnect clutch, in which the torque is suddenly transmitted from the torque input component to the torque output component when the interlock is initiated. The rotational speed of the torque input component must therefore correlate with the rotational speed of the torque output component when the clutch is actuated.

It is furthermore preferred if the clutch element is configured as a sliding sleeve. In particular, it is preferred if, in the circumferential direction, the sliding sleeve has interlocking connecting elements with slight play for interlocking connection of the torque input component to the torque output component.

It is also advantageous if the clutch element is mounted and/or guided such that it is axially displaceable between the actuating position and the decoupling position in which no torque is transmitted.

A favorable exemplary embodiment is also distinguished in that the torque input component and the torque output component are arranged coaxially. Thus it is advantageously possible for the two components to be coupled together in torque-transmissive fashion without intermediate stages.

It is furthermore suitable if the clutch element has a toothing, and the torque input component and the torque output component each have a counter-toothing, wherein the counter-toothing transmits a torque on cooperation with the toothing of the clutch element. This therefore means that for transmitting torque, the toothing of the clutch element simultaneously engages in the counter-toothing of the torque input component and the counter-toothing of the torque output component. If no torque is transmitted, the connection between the toothing of the clutch component and the counter-toothing of the torque input component, and/or between the toothing of the clutch component and the counter-toothing of the torque output component, is released. In other words, by translational movement, the clutch element is brought into a toothed engagement with the torque input component and the torque output component for torque transmission.

It is also advantageous if the counter-toothing of the torque input component and/or the counter-toothing of the torque output component are/is configured as external toothing. In particular, it is preferred if the counter-toothing of the torque input component and/or the counter-toothing of the torque output component are/is formed as a spur gear and/or with straight toothing.

It is also preferred if the counter-toothing of the torque input component and the counter-toothing of the torque output component are arranged at the same axial height. This means that the torque input component and the torque output component have the same toothing diameter. Thus it is possible for the counter-toothing to engage in the same toothing (namely of the clutch element) for torque transmission, so that in a simple fashion, torque can be transmitted from the torque input component to the torque output component without a translation ratio.

A favorable exemplary embodiment is furthermore distinguished in that the toothing of the clutch element is formed as an internal toothing. It is also preferred if the internal toothing is formed with a constant toothing diameter which corresponds to the toothing diameter of the torque input component and/or the toothing diameter of the torque output component.

Furthermore, it is possible to use other interlocking elements for interlocking force transmission on the clutch element, torque input component and torque output component.

In addition, it is advantageous if a lock is provided for axial positioning of the clutch element in the actuating position and/or the decoupling position. In particular, it is preferred if lock elements are formed on the clutch element and the torque input component or torque output component, which elements cooperate with each other such that on reaching an axial position (namely the actuating position or decoupling position) of the clutch element relative to the torque input component or torque output component, the clutch element is not translationally moved further in the axial direction.

Here, it is advantageous if the lock elements are formed as a ball preloaded by a spring in the radial direction and as detents formed in the radial direction, into which the ball is pressed under the spring preload in the actuating position or the decoupling position.

It is also preferred if a stop is provided for limiting the axial movement of the clutch element. In this way, the clutch element can advantageously be prevented from moving too far or further than necessary in the axial direction. In particular, it is advantageous if the stop is formed as a stop element protruding radially inwardly from the clutch element, preferably as a ring component, which is arranged such that it lies on the torque input component on reaching the actuating position and on the torque output component on reaching the decoupling position.

The object according to the disclosure is also achieved with a hybrid module comprising a first drive machine, which is permanently connected in torque-transmissive fashion to a transmission input shaft, and a second drive machine, which can be engageably connected in torque-transmissive fashion to the transmission input shaft and/or an output shaft of the first drive machine via such a clutch unit.

### BRIEF DESCRIPTION OF THE DRAWINGS

The figures are explained below with reference to drawings. The drawings show:

FIG. 1 a diagrammatic, longitudinal sectional depiction of a clutch unit according to the disclosure in a decoupling position in which no torque is transmitted, and

FIG. 2 a diagrammatic, longitudinal sectional depiction of the clutch unit in an actuating position in which torque is transmitted.

### DETAILED DESCRIPTION

The figures are purely diagrammatic and serve exclusively to explain the disclosure. The same elements carry the same reference signs.

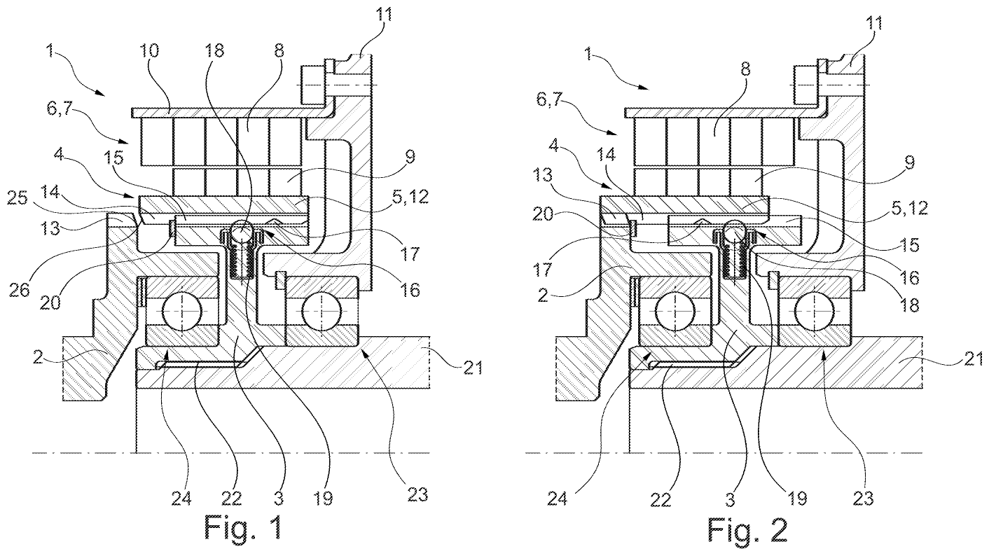

FIG. 1 shows a clutch unit 1 according to the disclosure for a powertrain of a motor vehicle. The clutch unit 1 has a torque input component 2 which acts as a drive element, for example of a drive machine (not shown). The clutch unit 1 also has a torque output component 3 which acts as an output element and for example is a transmission input shaft or an output shaft of a second drive machine. The torque input component 2 can be connected in torque-transmissive fashion to the torque output component 3 via an engageable clutch/disconnect clutch 4.

The clutch 4 has a clutch element 5 which can be moved by translational displacement into an actuating position or decoupling position. In the actuating position, the torque is transmitted from the torque input component 2 to the clutch element 5 via an interlocking connection, and from there to the torque output component 4 via an interlocking connection. Thus the clutch 4 is closed when the clutch element 5 is in an actuating position. In the decoupling position, the interlocking connection between the clutch element 5 and the torque input component 2 is released so that no torque is transmitted.

The translational displacement of the clutch element 5 is achieved by an electric motor 6 configured as a linear motor 7. On operation of the electric motor 6, the magnetic fields of a stator 8 and rotor 9 of the electric motor 6 act on each other such that the rotor 9 is moved translationally in the axial direction relative to the stator 8. The clutch element 5 is fixedly connected to the rotor 9 so that, in operation of the electric motor 6, the clutch element 5 is moved in the axial direction together with the rotor 9. The stator 8 is connected fixedly to a stationary housing 11 via a stator carrier 10.

The rotor 9 is arranged radially outside the clutch element 5 and coaxially to the clutch element 5, the torque input component 2 and/or the torque output component 3. The stator 8 is arranged coaxially to and radially outside the rotor 9.

The clutch element 5 is configured as a sliding sleeve 12 in annular form. The torque input component 2 has an external toothing 13 which is formed as a straight toothing, transmitting torque in the circumferential direction with a slight play. The clutch element 5 has an internal toothing 14 which is formed on a radial inside of the clutch element 5 as a straight toothing, transmitting torque in the circumferential direction with slight play, and on cooperation with the external toothing 13 of the torque input component 2, transmits torque from the torque input component 2 to the clutch element 5. The torque output component 3 has an external toothing 15 which is formed as a straight toothing, transmitting torque in the circumferential direction with slight play, and on cooperation with the internal toothing 14 of the clutch element 5, transmits torque from the clutch element 5 to the torque output component 3.

When the clutch element 5 is in the decoupling position, it is in toothed engagement only with the torque output component 3. The axial movement of the clutch element 5 into the actuating position moves the internal toothing 14 into the external toothing 13, so that the clutch element 5 is engaged with both the torque output component 3 and with the torque input component 2. The clutch element 5 can thus be pushed into the external toothing 14 only when the rotational speed of the torque input component 2 corresponds to the rotational speed of the clutch element 5, i.e. the rotational speed of the torque output component 3. In the actuating position, the internal toothing 14 is in toothed engagement with the external toothing 13 over the entire toothing length of the external toothing 13. In the decoupling position, the internal toothing 14 is in toothed engagement with the external toothing 15 over the entire toothing length of the torque output component 3.

The clutch unit 1 comprises a lock 16 which serves for axial positioning of the clutch element 5 relative to the torque output component 3 and hence to the torque input component 2. The lock 16 is formed by two detents 17 on the radial inside of the clutch element 5, and by a ball 18. The ball 18 is preloaded in the radial direction via a spring 19 and attached to the torque output component 3. The detents 17 are arranged in the clutch element 5 so that the clutch element 5 is either in the actuating position or in the decoupling position when the ball 18 lies in the first detent 17 or the second detent 17. The detents 17 have a triangular cross section so that an axial shift of the clutch element 5 guides the ball 18 out of the detents 17.

A stop 20 is formed on the clutch element 5 and lies with an axial side on the torque input component 2 when the clutch element 5 is in the actuating position, or with the other axial side on the torque output component 3 when the clutch element 5 is in the decoupling position. The stop 20 is formed as a ring component which protrudes radially inwardly from the clutch element 5 beyond the internal toothing 14.

The torque output component 3 is attached to a hollow shaft 21 via a shaft-hub connection 22. The torque is transmitted for example to a transmission input shaft or an output shaft of a drive machine via the hollow shaft 21. The torque output component 3 may also be formed integrally with the hollow shaft 21.

The hollow shaft 21 is mounted in the housing 11 via a first roller bearing 23, and on or in the torque input component 2 via a second roller bearing 24. The torque output component 2 is thus also mounted in the housing 11 via the first roller bearing 23, and on or in the torque input component 2 via the second roller bearing 24.

The external toothing 13 has a chamfer 25 on a side facing the torque output component 3 in the axial direction. The internal toothing 14 also has a chamfer 26, which corresponds in angle and size to the chamfer 25, on the side facing the torque input component 2 in the axial direction.

### LIST OF REFERENCE NUMBERS

1 Clutch unit

2 Torque input component

3 Torque output component

4 Clutch

5 Clutch element

6 Electric motor

7 Linear motor

8 Stator

9 Rotor

10 Stator carrier

11 Housing

12 Sliding sleeve

13 Input external toothing

14 Internal toothing

15 Output external toothing

16 Lock

17 Detent

18 Ball

19 Spring

20 Stop

21 Hollow shaft

22 Shaft-hub connection

23 First roller bearing

24 Second roller bearing

25 Chamfer

26 Chamfer

1. A clutch unit for a powertrain of a motor vehicle, comprising a torque input components which acts as a drive element and a torque output component which acts as an output element, wherein the torque input component can be connected to the torque output component in torque-transmissive fashion via an engageable clutch, wherein the clutch has a translationally movable clutch element configured and arranged such that in an actuation position, the clutch element allows a torque to be transmitted from the torque input component to the torque output component via an interlocking engagement.

2. The clutch unit as claimed in claim 1, wherein an electric motor is provided for translational movement of the clutch element.

3. The clutch unit as claimed in claim 2, wherein the electric motor is formed as a linear motor.

4. The clutch unit as claimed in claim 1, wherein the torque input component and the torque output component are configured and matched to each other such that a rotational speed of the torque input component and a rotational speed of the torque output component can be synchronized.

5. The clutch unit as claimed in claim 1, wherein the clutch element is configured as a sliding sleeve.

6. The clutch unit as claimed in claim 1, wherein the torque input component and the torque output component are arranged coaxially.

7. The clutch unit as claimed in claim 1, wherein the clutch element has a toothing, and the torque input component and the torque output component each have a counter-toothing, wherein the counter-toothing transmits a torque when engaged with the toothing of the clutch element.

8. The clutch unit as claimed in claim 1, wherein a lock is provided for axial positioning of the clutch element in the actuation position and/or a decoupling position.

9. The clutch unit as claimed in claim 1, wherein a stop is provided for limiting an axial movement of the clutch element.

10. A hybrid module comprising a first drive machine which is permanently connected in torque-transmissive fashion to a transmission input shaft, and a second drive machine which can be engageably connected in torque-transmissive fashion to the transmission input shaft and/or an output shaft of the first drive machine via a clutch unit as claimed in claim 1.

11. A clutch assembly for a hybrid module, comprising:
a torque input component;
a torque output component; and
a clutch configured to selectively connect the torque input component with the torque output component for torque transmission therebetween, the clutch including a sliding sleeve movable between an actuation position and a decoupled position,
wherein, in the actuation position:
a first toothing formed on a radial inside of the sliding sleeve is engaged with a second toothing formed on an outside of the torque input component such that torque is transmitted from the torque input component to the sliding sleeve; and
a third toothing formed on an outside of the torque output component is engaged with the first toothing such that torque is transmitted from the sliding sleeve to the torque output component.

12. The clutch assembly as claimed in claim 11, wherein, in the decoupled position, the first toothing is only in engagement with the third toothing such that no torque is transmitted between the torque input component and the sliding sleeve of the clutch.

13. The clutch assembly as claimed in claim 11, wherein the sliding sleeve is moved into the actuating position in response to a first rotational speed of the torque input component corresponding to a second rotational speed of the torque output component.

14. The clutch assembly as claimed in claim 11, wherein:
the first toothing includes a first chamfer formed on a side facing the torque input component in an axial direction;
the second toothing includes a second chamfer formed on a side facing the torque output component; and
the first chamfer corresponds in angle and size to the second chamfer.
